(19) United States
(12) Patent Application Publication
(10) Pub. No.: US 2005/0029753 A1
(43) Pub. Date: Feb. 10, 2005

(54) Drill chuck with a jaw control mechanism

(76) Inventor: Tsung-Hsun Yang, Tai-Ping City (TW)

Correspondence Address: FROMMER LAWRENCE & HAUG, 745 FIFTH AVENUE- 10TH FL., NEW YORK, NY, 10151, US

(21) Appl. No.: 10/636,934

(22) Filed: Aug. 7, 2003

(51) Int. Cl. B23B 31/12

(52) U.S. Cl. 279/58

(57) ABSTRACT

A drill chuck includes spring-biased jaws axially and radially displaceable within a chuck body so as to clamp a drilling bit thereamong. A coupling unit is mounted securely on the chuck body, and has an axial threaded portion extending axially and outwardly from the chuck body. A jaw control mechanism includes a driving member threadedly engaging the axial threaded portion of the coupling unit so as to be adjustable along the axial threaded portion, a pressing member disposed within the chuck body and seated on the jaws, and a pushing unit that is associated with and that is driven by the driving member, and that extends axially into the chuck body to abut against the pressing member.

### BACKGROUND OF THE INVENTION

1. Field of the Invention

The present invention relates to a drill chuck, more particularly to a drill chuck with a jaw control mechanism.

2. Description of the Related Art

Referring to FIGS. 1 and 2, a conventional drill chuck 1 is shown to include a chuck body 11, a plurality of spring-biased jaws 12, and a coupling unit 14. The chuck body 11 is formed with a bit-receiving opening 113 and a mounting end 115 opposite to the bit-receiving opening 113. The spring-biased jaws 12 are disposed in the chuck body 11, have top ends 121, and are axially and radially displaceable within the chuck body 11 so as to clamp a drilling bit 16 that is inserted into the chuck body 11 through the bit-receiving opening 113. The coupling unit 14 includes a cap 142 mounted securely on the mounting end 115 of the chuck body 11, a pressing member 13 disposed within the chuck body 11 and seated on the top ends 121 of the jaws 12, and a threaded driving shank 15 that has one end 151 threadedly engaging a threaded hole 143 in the cap 142 and extending therethrough to abut against the pressing member 13, and the other end 152 adapted to be fastened to a power drill 17 so as to be driven by the power drill 17. The pressing member 13 pushes the jaws 12 to move toward each other when the driving shank 15 is driven toward the pressing member 13, thereby permitting the jaws 12 to clamp the drilling bit 16.

One disadvantage of the conventional drill chuck 1 resides in that counterclockwise rotation of the drilling shank 15 for removal of tightened screws can result in loosening of the drilling shank 15, which, in turn, results in axial movement of the pressing member 13 away from the bit-receiving opening 113 in the chuck body 11 and hence radial movement of the jaws 12 away from one another, thereby dropping the bit 16 from the chuck body 11.

### SUMMARY OF THE INVENTION

Therefore, the object of this invention is to provide a drill chuck with a jaw control mechanism so as to overcome the aforesaid disadvantage of the prior art.

Accordingly, a drill chuck of the present invention is adapted to be connected to a power drill, and includes: a chuck body defining a rotation axis, and formed with a bit-receiving opening and a mounting end opposite to the bit-receiving opening; a plurality of spring-biased jaws disposed in the chuck body, having top ends, and axially and radially displaceable within the chuck body so as to clamp a drilling bit inserted into the chuck body through the bit-receiving opening; a coupling unit which is securely mounted on the mounting end of the chuck body and which defines an axial threaded portion extending axially and outwardly of the chuck body; and a jaw control mechanism mounted securely and adjustably on the coupling unit, and including a driving member that threadedly engages the axial threaded portion of the coupling unit so as to be adjustable along the axial threaded portion, a pressing member disposed within the chuck body and seated on the jaws, and a pushing unit that is associated with and that is driven by the driving member and that extends axially through the mounting end of the chuck body to abut against the pressing member in such a manner that tightening of the driving member relative to the pressing member results in axial movement of the pushing unit to abut against the pressing member, which, in turn, results in movement of the jaws toward one another so as to be adapted to securely clamp the drilling bit thereamong.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is an exploded perspective view of a conventional drill chuck;

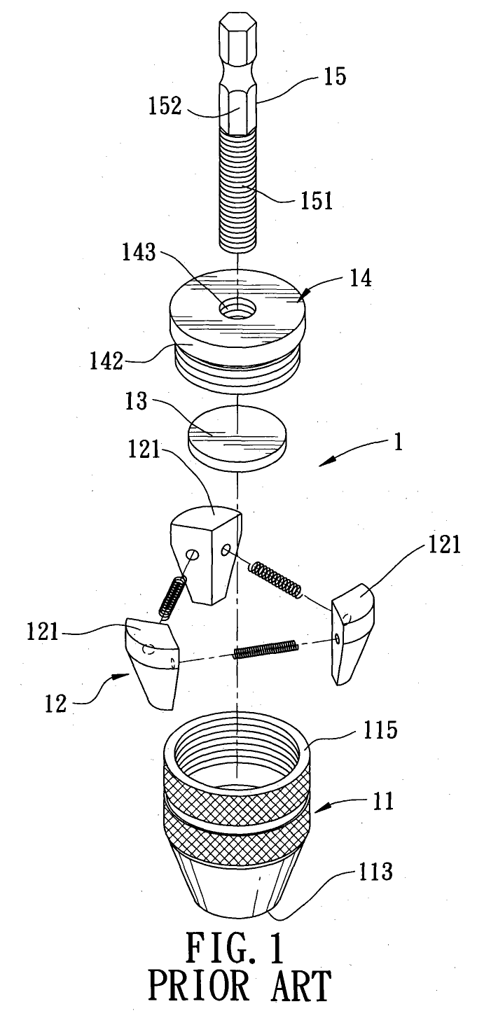

FIG. 2 is a sectional view of the conventional drill chuck;

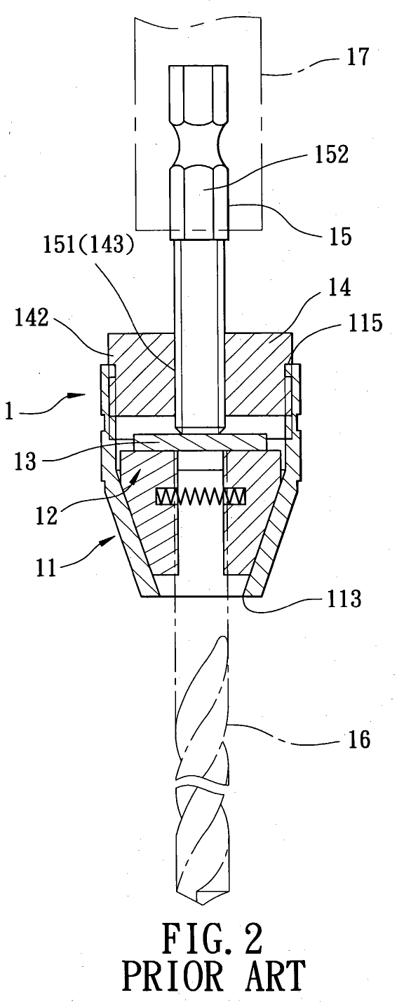

FIG. 3 is an exploded perspective view of the preferred embodiment of a drill chuck according to the present invention;

FIG. 4 is a sectional view of the preferred embodiment;

FIG. 5 is a sectional view illustrating how a drilling bit is clamped by spring-biased jaws of the preferred embodiment; and

FIG. 6 is a cross-sectional view of the preferred embodiment taken along lines VI-VI in FIG. 5, illustrating how the drilling bit is clamped by the spring-biased jaws.

### DETAILED DESCRIPTION OF THE PREFERRED EMBODIMENT

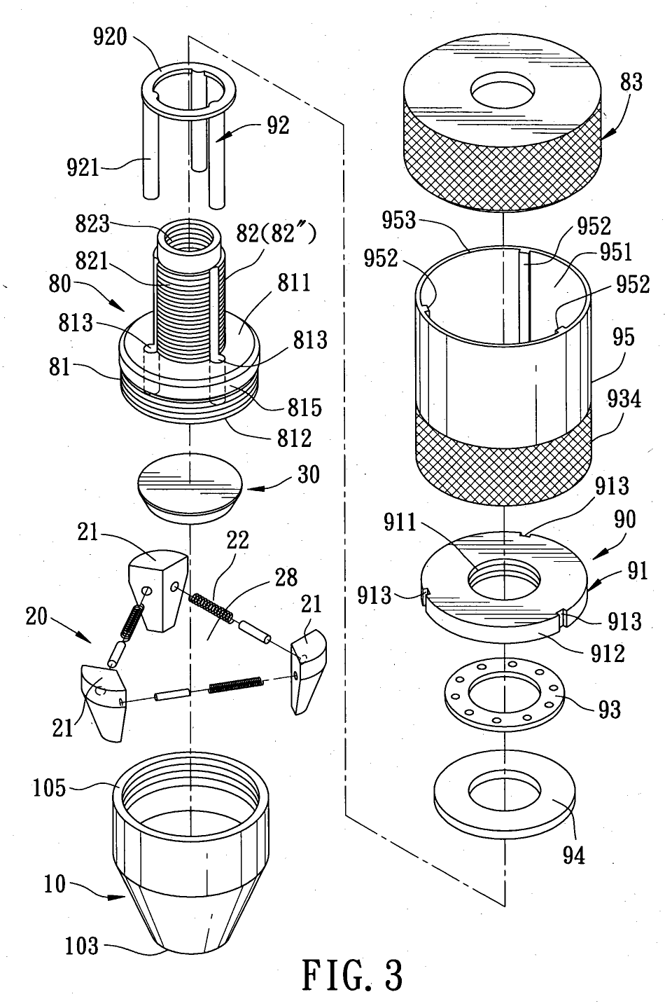

Referring to FIGS. 3 to 5, the preferred embodiment of a drill chuck according to the present invention is adapted to be connected to a power drill 100 through a driving shank 70 so as to be driven thereby, and is shown to include a chuck body 10, a jaw unit 20, a coupling unit 80 and a jaw control mechanism 90.

As illustrated, the chuck body 10 defines a rotation axis, and is formed with a bit-receiving opening 103 and a mounting end 105 opposite to the bit-receiving opening 103.

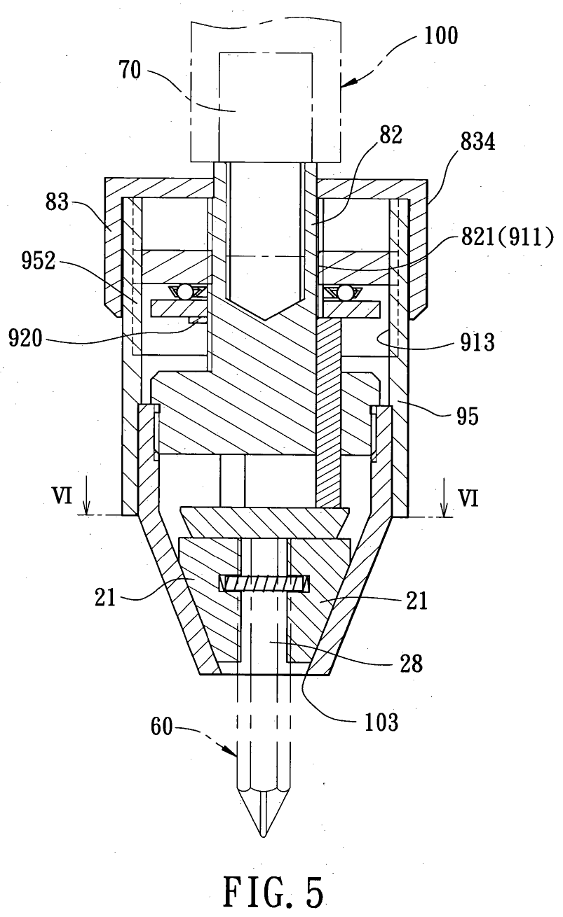

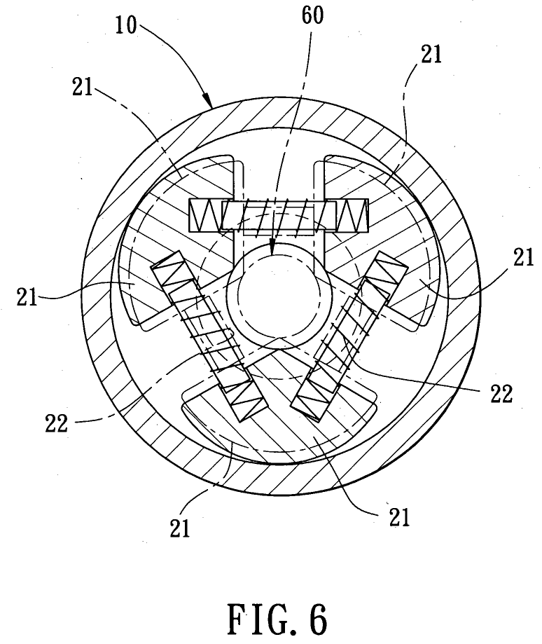

The jaw unit 20 includes three jaws 21 and three urging members 22. The jaws 21 are disposed in the chuck body 10 and cooperatively define a gap 28 thereamong. Each of the urging units 22 is disposed between an adjacent pair of the jaws 21 so as to push the jaws 21 to abut against an inner face of the chuck body 10 in such a manner that the jaws 21 are axially and radially displaceable within the chuck body 10 (see FIG. 6) to clamp a drilling bit 60 (see FIG. 5) that is inserted into the chuck body 10 through the bit-receiving opening 103.

The coupling unit 80 is securely mounted on the mounting end 105 of the chuck body 10, and defines an axial threaded portion 82″ that extends axially and outwardly of the chuck body 10.

The jaw control mechanism 90 is mounted securely and adjustably on the coupling unit 80, and includes a driving member 91, a pressing member 30, and a pushing unit 92. The driving member 91 threadedly engages the axial threaded portion 82″ of the coupling unit 80 so as to be adjustable along the axial threaded portion 82′. The pressing member 30 is disposed within the chuck body 10, and is seated on the jaws 21. The pushing unit 92 is associated with and is driven by the driving member 91, and extends axially through the mounting end 105 of the chuck body 10 to abut against the pressing member 30 in such a manner that tightening of the driving member 91 relative to the driving member 91, i.e., axial movement of the driving member 91 toward the pressing member 30, results in axial movement of the pushing unit 92 to abut against the pressing member 30, which, in turn, results in radial movement of the jaws 21 against the urging action of the urging members 21 toward one another, thereby minimizing the gap 28 among the jaws 21. As such, the drilling bit 60 can be clamped securely among the jaws 21 (see FIG. 5).

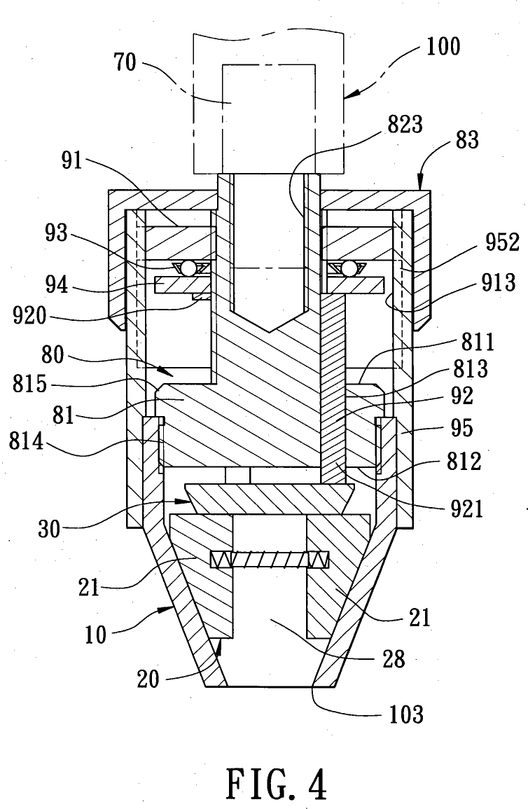

In this preferred embodiment, the coupling unit 80 includes a chuck-connecting member 81 and a coupling tube 82. The chuck-connecting member 81 is mounted securely on the mounting end 105 of the chuck body 10, and has an end flange 815 that abuts against the mounting end 105 of the chuck body 10. The chuck-connecting member 81 is further formed with a plurality of rod-extension holes 813 which are angularly spaced apart from one another relative to the rotation axis of the chuck body 10 and which extend through top and bottom faces 811,812 of the chuck-connecting member 81. The coupling tube 82 extends co-axially and integrally from the chuck-connecting member 81, and is formed with an external thread 821 defining the axial threaded portion 82″ of the coupling unit 80. The driving shank 70 is fastened securely to an inner thread 823 of the coupling tube 82 and is adapted to be connected to the power drill 100 (see FIG. 4). The pushing unit 92 includes an annular coupling disc 920 co-axially sleeved around the coupling tube 82, and a plurality of angularly spaced apart pushing rods 921 extending from the coupling disc 920 through the rod-extension holes 813 in the chuck-connecting member 81 to abut against the pressing member 30.

The jaw control mechanism 90 further includes a bearing retention seat 94 disposed between the driving member 91 and the coupling disc 920 of the pushing unit 92, and a bearing unit 93 sandwiched between the driving member 91 and the bearing retention seat 94. The driving member 91 is annular in shape, and has an inner thread 911 threadedly engaging the external thread 821 of the coupling tube 82, and an annular outer surface 912 formed with a plurality of axially extending engaging grooves 913. A rotatable sleeve 95 is sleeved on the driving member 91, encloses the mounting end 105 of the chuck body 10, and has an inner face 951 formed with a plurality of axially extending tongues 952 which project radially and inwardly therefrom to respectively engage the engaging grooves 913 in the driving member 91 so as to permit co-rotation of the driving member 91 with the rotatable sleeve 95.

An annular cap 83 is co-axially sleeved on the coupling tube 82. The outer surface of the rotatable sleeve 95 is provided with anti-slip knurls 934 to facilitate gripping of the same so as to drive the rotatable sleeve 95 in order to the tightening and loosening actions of the driving member 91 relative to the chuck body 10.

With the inclusion of the driving member 91 and the pushing unit 92 in the drill chuck of the present invention and since the driving shank 70 is not directly in contact with the pressing member 30 in the chuck body 10, the aforesaid disadvantage of the prior art is accordingly overcome.

With this invention thus explained, it is apparent that numerous modifications and variations can be made without departing from the scope and spirit of this invention. It is therefore intended that the invention be limited only as indicated in the appended claims.

1. A drill chuck adapted to be connected to a power drill, comprising:
a chuck body defining a rotation axis, and formed with a bit-receiving opening and a mounting end opposite to said bit-receiving opening;
a plurality of spring-biased jaws disposed in said chuck body, having top ends, and axially and radially displaceable within said chuck body so as to be adapted to clamp a drilling bit inserted into said chuck body through said bit-receiving opening;
a coupling unit which is securely mounted on said mounting end of said chuck body and which defines an axial threaded portion extending axially and outwardly of said chuck body; and
a jaw control mechanism mounted securely and adjustably on said coupling unit, and including a driving member that threadedly engages said axial threaded portion of said coupling unit so as to be adjustable along said axial threaded portion, a pressing member disposed within said chuck body and seated on said jaws, and a pushing unit that is associated with and that is driven by said driving member, and that extends axially through said mounting end of said chuck body to abut against said pressing member in such a manner that tightening of said driving member relative to said pressing member results in axial movement of said pushing unit to abut against said pressing member, which, in turn, results in movement of said jaws toward one another so as to be adapted to securely clamp the drilling bit thereamong.

2. The drill chuck assembly as defined in claim 1, wherein said coupling unit includes a chuck-connecting member that is mounted securely on said mounting end of said chuck body and that is formed with a plurality of rod-extension holes which are angularly spaced apart from one another relative to the rotation axis, and a coupling tube that extends co-axially and integrally from said chuck-connecting member and that is formed with an external thread defining said axial threaded portion of said coupling unit, said pushing unit including a plurality of pushing rods extending from said driving member through said rod-extension holes in said chuck-connecting member to abut against said pressing member.

3. The drill chuck as defined in claim 2, wherein said pushing unit further includes an annular coupling disc fixed to said pushing rods and co-axially sleeved around said coupling tube.

4. The drill chuck as defined in claim 3, wherein said jaw control mechanism further includes a bearing retention seat disposed between said driving member and said coupling disc of said pushing unit, and a bearing unit sandwiched between said driving member and said bearing retention seat.

5. The drill chuck as defined in claim 4, wherein said driving member is annular in shape, and has an annular outer surface formed with a plurality of axially extending engaging grooves, said jaw control mechanism further including a rotatable sleeve that is sleeved on said driving member, that encloses said mounting end of said chuck body, and that has an inner face formed with a plurality of axially extending tongues which project radially and inwardly therefrom to respectively engage said engaging grooves in said driving member so as to permit co-rotation of said driving member with said rotatable sleeve.
